(19) United States
(12) Patent Application Publication
(10) Pub. No.: US 2023/0031580 A1
(43) Pub. Date: Feb. 2, 2023

(54) DOWNSPOUT DIVERTER

(71) Applicant: Stormwell Inc., Guelph (CA)

(72) Inventors: Timothy Howard NEEB, Guelph (CA); Tristan ZIMMERMANN, Guelph (CA)

(21) Appl. No.: 17/784,776

(22) PCT Filed: Dec. 16, 2020
(86) PCT No.: PCT/CA2020/051731

§ 371 Date: Jun. 13, 2022

Related U.S. Application Data
(60) Provisional application No. 62/948,855, filed on Dec. 17, 2019.

(51) Int. Cl. E04D 13/08

(52) U.S. Cl. CPC E04D 13/08; E04D 2013/0813; E04D 2013/0833; E04D 2013/0866

(57) ABSTRACT

A downspout diverter for diverting collected water, such as rainwater. The diverter either directs the collected water towards a storage tank, such as a rainwater harvesting storage tank to towards an outflow portion. When the collected water is directed towards the outflow portion, the water exits the diverter spilling the water to the ground.

### CROSS-REFERENCE TO OTHER APPLICATIONS

The disclosure claims priority from U.S. Provisional Application No. 62/948,855 filed Dec. 17, 2019, the contents of which are hereby incorporated by reference.

### FIELD

The disclosure is generally directed at diverters, and more specifically to an eavestrough downspout diverter valve.

### BACKGROUND

Water is a valuable resource and conservation of water is important. Some uses of water require that the water be potable; however there are many applications such as flushing toilets, laundry, and watering lawns and gardens where potable water is not necessary. In these applications it is possible to use rainwater. Rainwater harvesting systems collect water off of building roofs and store it in storage tanks until the water it is needed. When storage tanks reach their capacity new rainwater needs to be re-directed from the tank and away from the building so that any overflow may not cause damage to the building.

Therefore, there is provided a novel downspout diverter.

### SUMMARY

The disclosure is directed at a downspout diverter. In one embodiment, the disclosure is directed at an eavestrough downspout diverter valve for use in a rainwater harvesting system.

In one aspect of the disclosure, there is provided a downspout diverter including a main body portion including: an inlet portion; a harvesting outlet portion; and an overflow outlet portion; wherein when downspout rainwater is received via the inlet portion, the downspout rainwater is directed towards the harvesting outlet portion and when excess rainwater is received via the harvesting outlet portion, the rainwater is directed at the overflow outlet portion.

In another aspect, the diverter further includes a flap covering the overflow outlet portion. In a further aspect, the flap includes a sealing edge. In yet another aspect, the main body portion includes a seat for receiving the sealing edge. In a further aspect, the main body portion further includes a housing defining the inlet portion, the harvesting outlet portion and the overflow outlet portion. In yet another aspect, the housing includes a pair of body portion components.

In another aspect, the inlet portion and the harvesting outlet portion are connected via a conduit portion. In a further aspect, the body portion components comprise a set of conduit engaging features whereby when the pair of body portion components are connected, the set of conduit engaging features engaging the conduit to locate the conduit. In yet a further aspect, the set of conduit engaging features includes a set of slots. In an aspect, the conduit includes flanges for mating with the set of slots. In yet another aspect, the set of conduit engaging features include a set of protrusions. In another aspect, the conduit includes a set of apertures for receiving the set of protrusions.

In another aspect, the conduit includes a conduit overflow portion whereby rainwater that is received from the harvesting outlet portion is directed to the overflow outlet portion via the conduit overflow portion. In another aspect, a bottom portion of the main body portion is angled to direct the excess rainwater towards the overflow outlet portion.

In another aspect, the inlet portion is connected to a downspout. In a further aspect, the outlet portion is connected to a pipe. In yet another aspect, the main body portion includes a residual zone and a flow capacity zone.

### BRIEF DESCRIPTION OF THE DRAWINGS

The foregoing and other features and advantages of the disclosure will be apparent from the following description of embodiments thereof as illustrated in the accompanying drawings. The accompanying drawings, which are incorporated herein and form a part of the specification, further serve to explain the principles of the disclosure and to enable a person skilled in the pertinent art to make and use the invention. The drawings are not to scale.

FIG. 1 a side cross-sectional view of a downspout diverter;

FIG. 2 is a perspective view of a downspout diverter;

FIG. 3 is a rear view of a downspout diverter;

FIG. 4 is a side cross-sectional view of another embodiment of a downspout diverter;

FIG. 5 is a side view of the downspout diverter of FIG. 4;

FIG. 6 is an exploded perspective view of the downspout diverter of FIG. 4;

FIG. 7 is a side cross-sectional view of the downspout diverter of FIG. 4;

FIG. 8 is a side cross-sectional view of a further embodiment of a downspout diverter of FIG. 4;

FIG. 9 is a side cross-sectional view of another embodiment of a downspout diverter with a sealing portion in an uninstalled position; and

FIG. 10 is a side cross-sectional view of the downspout diverter of FIG. 9 with a sealing portion in an installed position.

### DETAILED DESCRIPTION

Specific embodiments of the present disclosure are now described with reference to the figures, wherein like reference numbers indicate identical or functionally similar elements. The following detailed description is merely exemplary in nature and is not intended to limit the disclosure or the application and uses of the disclosure. Directional terms used within the specification are with respect to the way in which the figure is presented unless otherwise described. Furthermore, there is no intention to be bound by any expressed or implied theory presented in the preceding technical field, background, brief summary or the following detailed description.

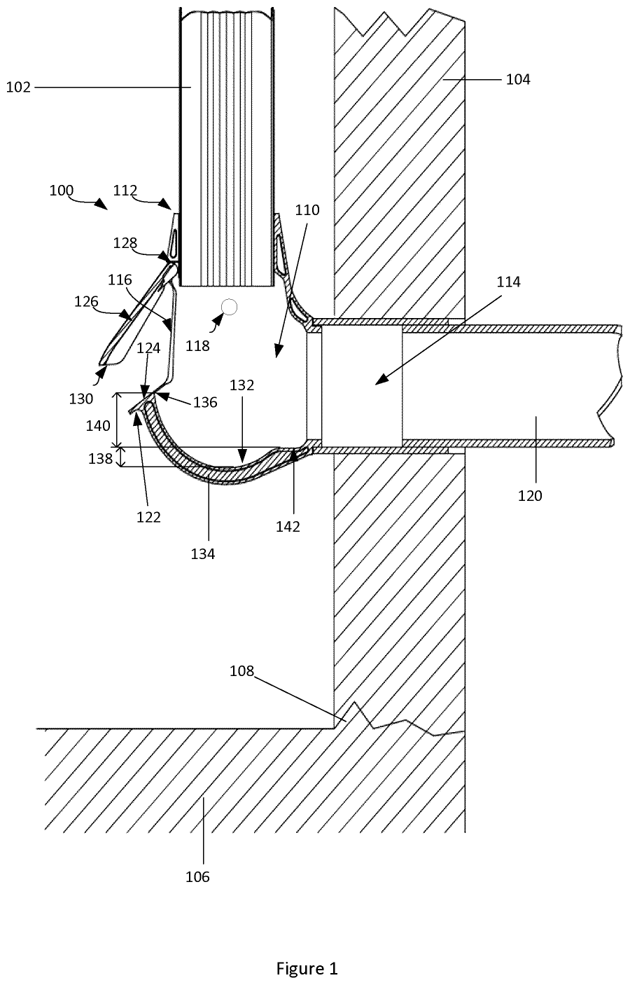

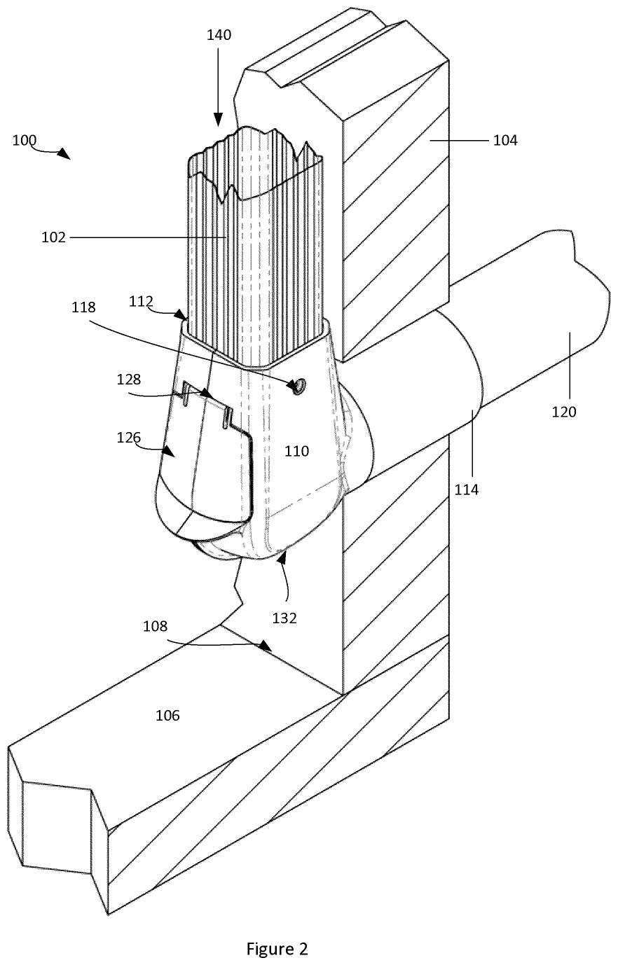

FIGS. 1 and 2 are side and perspective views of a downspout diverter in its environment. As shown in FIGS. 1 and 2, a downspout diverter 100 is installed at a downstream position or bottom end of a downspout 102. In one embodiment, the downspout 102 is connected to a rainwater collection system that is installed on a rooftop, or roof, of a building 104 to capture/collect rainwater shed off of the roof. The downspout diverter 100 directs the collected rainwater towards a storage tank or away from where the building 104 meets the ground 106, such as at a base or foundation 108 of the building 104.

In one embodiment, the rainwater collection system (which may or may not form part of the disclosure) includes lengths of eavestroughs (not shown) and one or more downspouts 102. Eavestroughs are installed around the building under the roof line to capture the rainwater as it is shed off the roof. One or more downspouts 102 are attached to the eavestroughs and extend down the length of the building 104 from the bottom of the eavestrough towards the ground 106. Rainwater collected by the eavestroughs is directed to one of the downspouts 102 which then carries the rainwater down from the eavestrough towards the downspout diverter 100 where it is diverted by the downspout diverter 100 either to a storage tank or the ground.

Downspout diverter or diverter 100 has a main body 110, an inlet, or inlet portion 112, a harvesting outlet or harvesting outlet portion 114, and an overflow outlet or overflow outlet portion 116. Inlet portion 112 receives a bottom end of the downspout 102 and is fastened to the downspout 102 by a fastening apparatus 118. Examples of a fastening apparatus 118 include, but are not limited to, a rivet, a screw, or other known fasteners. Harvesting outlet 114 is connected to a pipe or series of pipes 120 which may extend through the building 104 and connect to a storage tank (not shown), which may be seen as a rainwater harvesting storage tank, located inside the building 104. In some embodiments, the harvester outlet portion 114 may be located within a wall of the building 104 whereby a connection between the output portion 114 and the pipe 120 is inside the building 104 and, in other embodiments, the pipe 120 may be located within the wall of the building 104 where the connection between the harvester portion 114 and the pipe 120 is outside the building 104. In one embodiment, the downspout diverter 100 may be retro-fitted to pipes 120 that have previously been installed in the building. In another embodiment, the downspout diverter 100 may include a length of pipe extending from the harvesting outlet portion 114 that is then connected or attached to a storage tank within the building. In this embodiment, a hole may be required to be drilled into the wall of the building 104 to insert the pipe extending from the harvesting outlet portion 114. In yet another embodiment, the storage tank and the downspout diverter may be seen as a rainwater harvesting system whereby installation of the rainwater harvesting system through the wall of the building is required. Although not shown, the harvesting outlet 114 may include a connector component that enables the harvesting outlet 114 to be attached to the pipe 120. Depending on the downspout diverter embodiment, the connector component may also be attached at an end of a pipe extending from the harvesting outlet 114.

The main body 110 may include a flange or lip 122 and a seat 124 adjacent the overflow outlet 116. A flap 126 is attached to the main body 110 of the diverter 100, by a hinged, or pivoting, connection 128. The flap 126 has the hinge connection 128 at one end and a sealing portion 130 on the end opposite the hinged connection 128. In FIG. 1, the flap 126 is shown in an open position, while in FIG. 2, the flap 126 is shown in a, default, closed position. In one embodiment, when in the closed position, a weight and orientation of the flap 126 locates the flap 126 so that the sealing portion 130 rests against seat 124 to cover and close the overflow outlet 116. If desired, an additional closing force could be provided by the use of a spring hinge connection to provide a force to bias the flap 126 in the closed position. In this embodiment, the additional force is selected such that it is high enough to bias the flap 126 in the closed position but low enough that the pressure of the water against the flap 126 in an overflow scenario will be sufficient to open the flap 126. The flap 126 may also protect against unwanted animals and insects from entering the diverter 100 which may contaminate the rainwater and, possibly enter the building 104.

In the current embodiment, the main body 110 of the downspout diverter 100 has a concave bottom portion 132 formed by a bottom wall 134 of the main body 110 that extends lower than an inner bottom edge 136 of overflow outlet 116. Bottom portion 132 may be seen as having a concave well shape which can receive and contain rainwater that is delivered via the downspout 102. In one embodiment, the bottom portion 132 is sized, and shaped, to provide capacity to receive a certain or predetermined amount of rainwater flow and divert or direct the collected rainwater away from the inner bottom edge 136 (or the overflow portion 116) until a predetermined amount of rainwater is stored in the bottom portion 132 thereby applying a force against the flap 126 to open the flap 126 allowing excess rainwater to exit the diverter to the ground 106 away from the foundation 108 of the building 104.

As further shown in FIG. 1, the bottom portion 132 may include a residual zone 138 and a flow capacity zone 140. The residual zone 138 may be seen as the area of the main body 110 that is formed or located between the bottom wall 134 and an outlet lead in profile 142 on the inside of the bottom wall 134 adjacent the harvesting outlet 114. The outlet lead in profile 142 is lower than and adjacent the bottom portion 132 and rises up to meet the bottom inside wall of pipe 120 adjacent the harvesting outlet 114. Once the residual zone 138 is filled with rainwater any new rainwater coming in flows in the flow capacity zone 140 over the outlet lead in profile 142 through harvesting outlet 114 and into the pipe 140 towards the rainwater harvesting tank located downstream. In other embodiments, the residual portion 138 is optional and it would be possible to have a diverter 100 with a shape that does not extend below the bottom inside wall of the pipe, therefore having a bottom portion that only has a flow capacity zone. In other words, the bottom wall 134 of the diverter 100 may align with a bottom portion of the pipe 120. In the current embodiment, the concave shape of the bottom portion 132 also acts to cup and calm the water when it flows down from the downspout 102 into the diverter 100. Although shown as being concave, it is understood that other shapes are possible.

In use, diverter 100 receives rainwater from the downspout 102 through inlet 112 and directs it either through harvesting outlet 114 towards the rainwater harvesting storage tank (not shown) located inside building 104 or through overflow outlet 116 whereby the rainwater spills to ground 106.

In operation, the diverter 100 is initially or typically in the default position shown in FIG. 2 with the flap 126 in the closed position. When rainwater enters the diverter 100, such as in the direction of arrow 140, from the downspout 102 through inlet 112, the rainwater collects in the bottom portion 132 until the residual zone is filled and is then directed through harvesting outlet 114 to pipe 120 which then empties the rainwater into the harvesting storage tank located inside building 104 downstream of the diverter 100. The rainwater harvesting storage tank receives rainwater from the diverter 100 when there is room in the tank to accept the water.

When a level of water in the storage tank reaches a predetermined, or maximum, amount or level, a shut off valve located downstream of the diverter 100 either upstream of or inside the storage tank will close to prevent or stop any additional rainwater from entering the tank via pipe 120. In some embodiments, the rainwater harvesting storage tank may be equipped with a level sensor and a shut off valve. It is also possible that there is no shut off valve for the tank and instead, when the storage tank is filled, the excess water begins to back up the pipe 120 to the diverter 100.

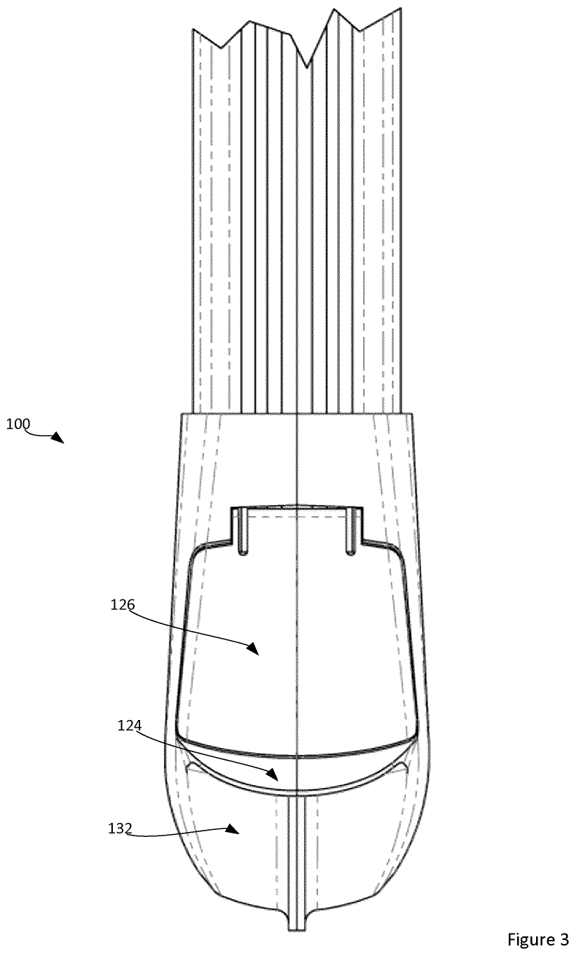

When no further rainwater can flow out of the harvesting outlet portion 114 towards the storage tank, such as after the shut off valve has closed, the rainwater entering the diverter 100 from the downspout 102 will reach the closed valve and/or travel back up pipe 120 towards the diverter 100. Once the rainwater backs up into the diverter 100, it will fill up the bottom portion 132 until the level of water in the diverter 100 reaches the inner bottom edge 136 of overflow outlet 116 where it will begin to push on, or urge, the flap 126 outward thereby disengaging the sealing portion 130 from the seat 124 and opening the flap 126 as shown schematically in FIG. 1. FIG. 3 provides another view of the diverter in the closed position. Once the flap 126 is pushed open, the rainwater can then spill out of the overflow outlet 116 in a direction away from the base 108 of the building 104.

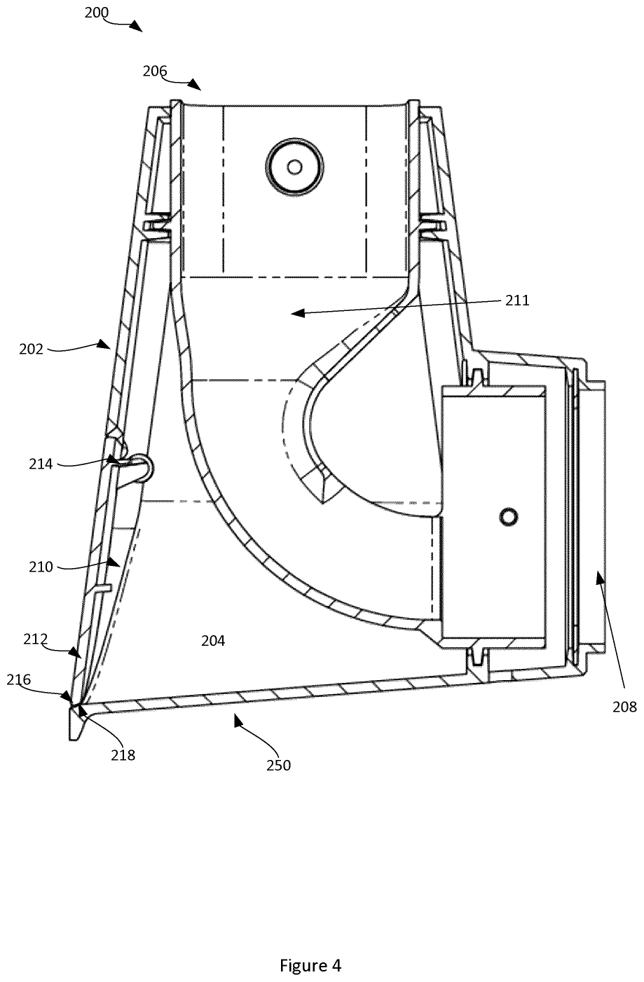

Another embodiment of a downspout diverter is shown in FIGS. 4 to 8. Diverter 200, as in the previous embodiment, transfers rainwater from a rainwater collection system to a tank installed in a building, and when the tank is full diverts the water out of the diverter 200 to spill to ground. The embodiment in FIGS. 1 to 3 show a diverter configuration that spills water to the ground away from the building, preventing or reducing the likelihood of damage to the building when there is an overflow scenario and/or wanted flooding of an area inside the building.

FIG. 4 shows a cross sectional view of diverter 200 which has a main body 202 which is hollow and forms or includes an overflow cavity 204. Main body 202 has a main body inlet 206, a main body, or harvesting, outlet 208, and an overflow outlet 210. The main body 202 further includes a rainwater conduit 211 that is located in the overflow cavity 204 and connected to the main body inlet 206.

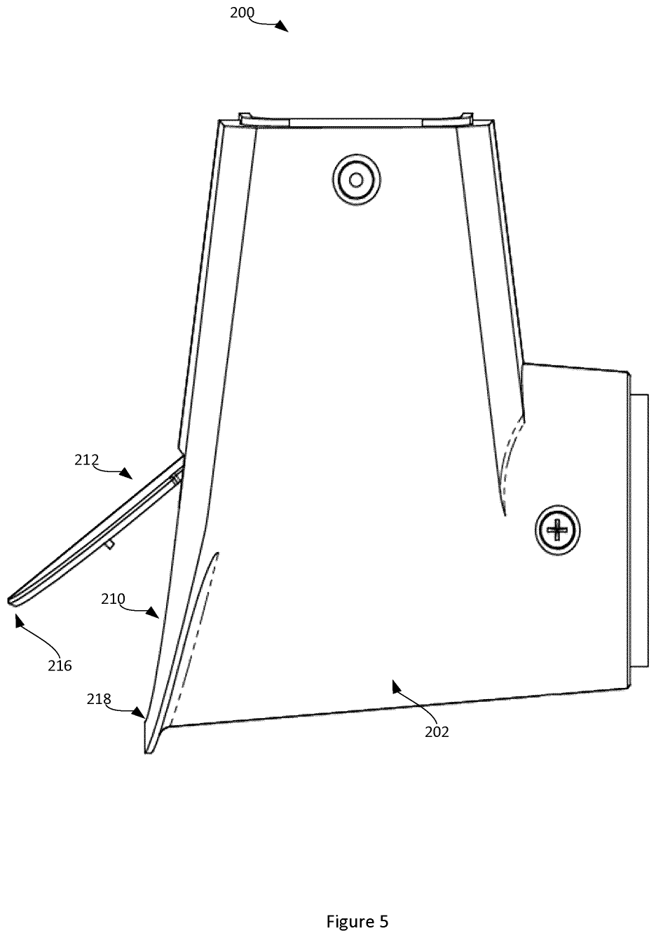

The overflow outlet 210 is covered by a flap 212 which is connected to the main body 202 via a hinged, or pivoting, connection 214. The flap 212 further includes a sealing edge surface 216 (seen in FIG. 5) that is in contact with a seat 218 located within the main body 202 when the flap 212 is in a closed position. When in the closed position, the flap 212 covers the overflow outlet 210 such as schematically shown in FIG. 4. In FIG. 5, the flap 212 is shown in an open position, whereby the overflow outlet 210 is uncovered.

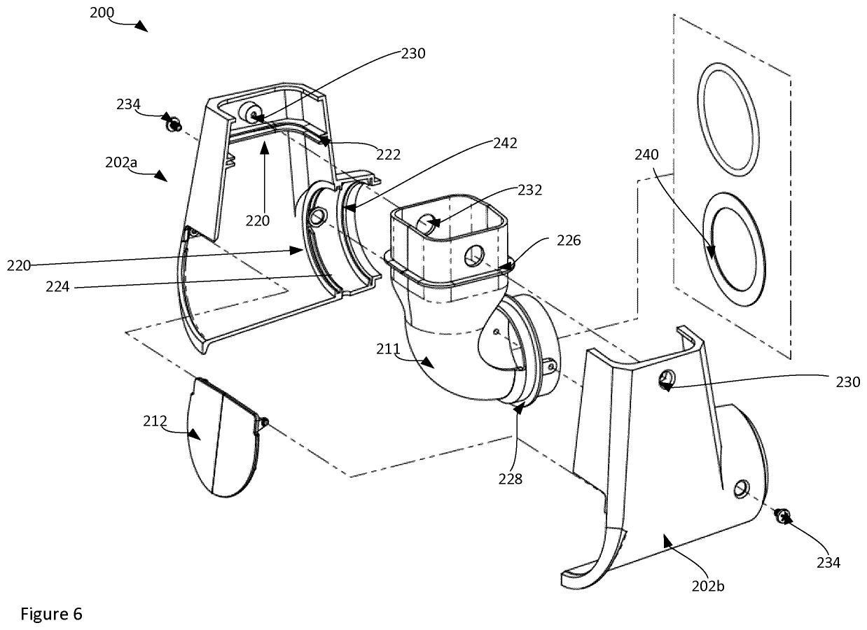

FIG. 6 shows an exploded view of diverter 200. As shown in FIG. 6, the main body 202 includes two body components 202a and 202b. In the current embodiment, the body components 202a and 202b may be seen as body half components. On an inside surface of at least one of the body components, either body component 202a or 202b or both, the body component includes or the body components include a number of conduit engaging features 220 designed to engage, locate, and/or fix the conduit 211 in place inside the main body 202 when the body components 202 are joined and/or fastened to each other forming the main body 202 of the diverter 200.

In the current embodiment, the conduit engaging and/or locating features 220 include a set of slots such as inlet slot 222 and outlet slot 224 for receiving complementary inlet conduit flange 226 and outlet conduit flange 228, respectively where the inlet conduit flange 226 and outlet conduit flange are formed on an outside of conduit 211. For further location and stability of the conduit 211, the conduit engaging features 220 may further include a post 230 extending from the inside surface of a body component 202. Other types and configurations of conduit engaging or locating features are contemplated for holding the conduit 211 in place within the main body 202 when the diverter 200 is assembled.

When the main body components 202 are assembled together, the post(s) 230 are received by locating apertures 232 on each side of the conduit 211. Although not fully shown, in the current embodiment, the body component 202b has the same conduit engaging features 220 as body component 202a. As such, when the conduit 211 is sandwiched between the two main body components, the inlet conduit flange 226 and the outlet conduit flange 228 mate with the corresponding inlet 222 and outlet 224 slots on the body components 202a and 202b. In one embodiment, the two main body components may be fastened together using adhesives or mechanical fasteners.

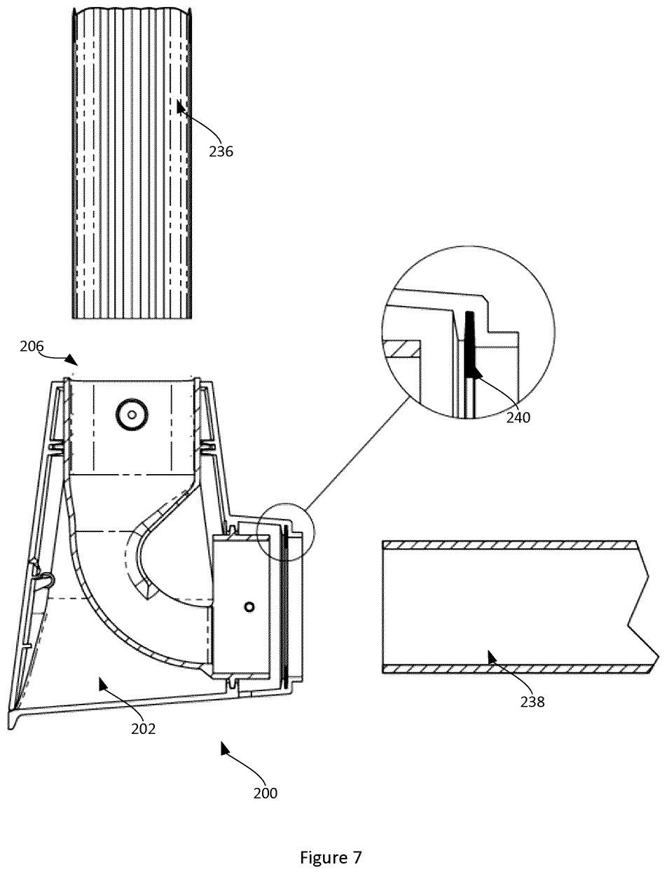

In one embodiment, the diverter 200 may be seen as an assembly of the conduit 211, the flap 212, and the two main body components 202a and 202b. In an embodiment, the diverter is made of plastic molded parts which are fastened together although the diverter 200 could be manufactured in a multitude of ways including split into more or less components which are fastened together or even 3-D printed as a single component using additive manufacturing. Fasteners 234 may be used to secure the downspout 236 (FIG. 7) and the harvesting pipe 238 (FIG. 7) to the main body 210. Fastener 234 can be a rivet, screw, or other known fastener.

As further shown in FIG. 6, the diverter 200 may include an outlet seal 240 which is received in a seal slot 242 formed on the inside surface of each of the main body components 202a and 202b. It is understood that in some embodiments, there may not be an outlet seal 240. The function of the outlet seal 240 will be described in more detail below.

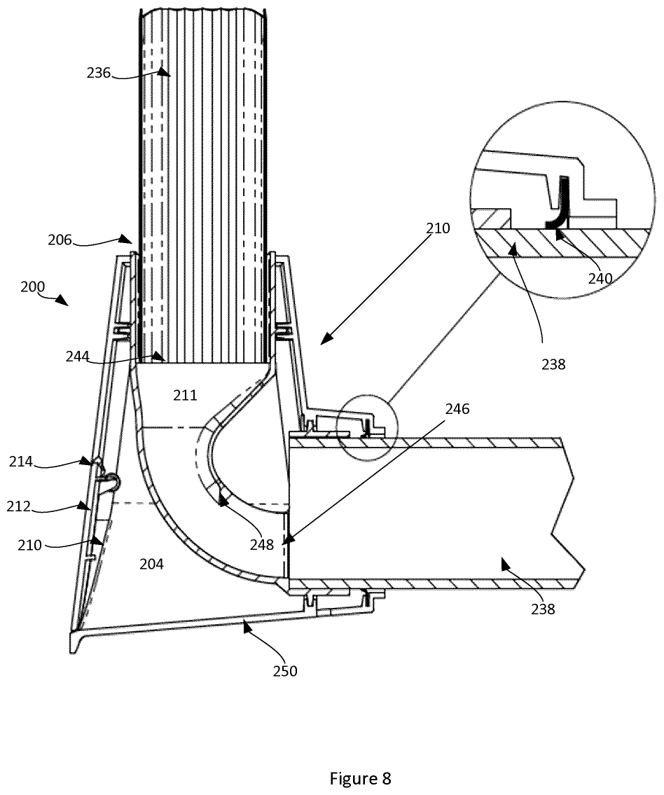

In FIG. 7, the diverter 200 is shown fully assembled prior to being connected to the downspout 236 and the harvesting pipe 238. Outlet seal 240 is installed and configured to extend radially within main body outlet 208 (FIG. 4) so that when the harvesting pipe 238 is inserted into the main body outlet 208 (as shown in FIG. 8), the outlet seal 240 bends and engages an outside surface of the harvest pipe 238 to form a seal between the main body 202 and the harvesting pipe 238. This assists to prevent or reduce the likelihood of water from leaking out from around the outside of harvesting pipe 238.

Continuing with FIG. 8, rainwater conduit 211 has a conduit inlet 244 which receives, and is in close proximity to, a bottom end of the downspout 236. In the current embodiment, the conduit inlet 244 extends just past the main body inlet 206, however it is possible that the conduit inlet 244 may be flush with the main body inlet 206 or contained within the main body 202 and not extend to or past the main body inlet 206.

In use, rainwater flows from the downspout 236 into the diverter 200 via the rainwater conduit 211 which provides an enclosed pathway for the water to flow through the diverter 200. The conduit 211 further includes a conduit outlet 246 located at the downstream end of the diverter and the conduit overflow section. In the current embodiment, the conduit overflow section 248 is an opening located between the conduit inlet 244 and the conduit outlet 246 on a top side of the conduit so that as water flows through the conduit 211 from the conduit inlet 244 through to the outlet 246, the rainwater will not normally exit though the conduit overflow section or opening 248.

The conduit outlet 246 (which may also be seen as the main body outlet 208) is connected to the harvesting pipe 238 or a series of pipes which extend through a building and connect to a rainwater harvesting storage tank located inside the building, such as discussed above. Also as discussed above, provided that there is room in the storage tank to accept the rainwater, the rainwater will flow out of the conduit outlet 246 to the harvesting pipe 238 and into the tank.

When the water level in the storage tank reaches a predetermined level, rainwater will no longer be able to flow from the diverter 200 to the tank. Instead the rainwater will start to back up harvesting pipe 238 towards the diverter 200. Once the rainwater backs up and reaches the diverter 200, it will flow back through the conduit outlet 246 and travel up the conduit 211 until it reaches the conduit overflow section or exit 248 where it may exit the conduit 211 via an opening in the conduit overflow section 248 into the overflow cavity 204 of the diverter 200.

In the current embodiment, a bottom wall 250 of the main body 202 is sloped downward to guide the excess rainwater towards the overflow outlet 210 where the force of the rainwater pushes open the flap 212. Once the flap 212 is pushed open, the excess rainwater can then spill out of the overflow outlet 210 falling to the ground.

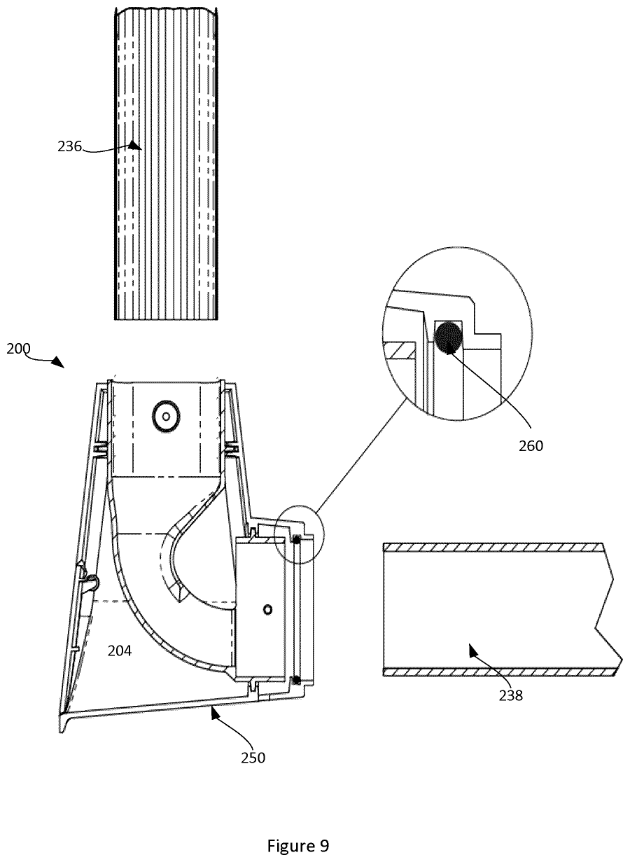

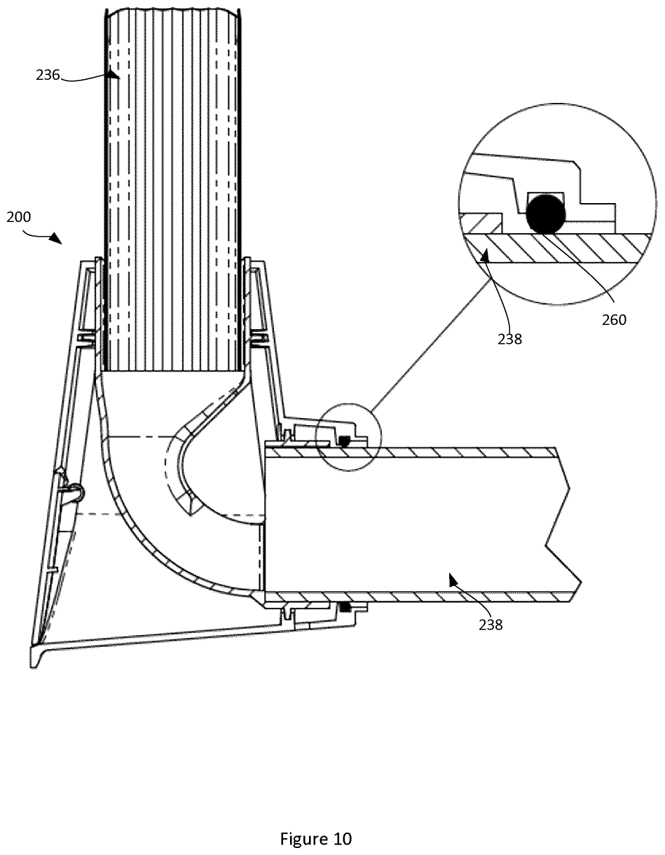

Turning to FIGS. 9 and 10, another embodiment of a sealing portion is shown. In the current embodiment, the sealing portion 260 may be an O-ring. The main body components of the diverter may include apparatus for engaging or receiving the O-ring. FIG. 9 shows the sealing portion, seen as O-ring 260 prior to the harvesting pipe 238 being installed. When the harvesting pipe 238 is installed (such as shown in FIG. 10), the O-ring may slightly compress against the harvesting pipe 238 to create a seal between the diverter 200 and the pipe 238.

Although all embodiments have been shown in relation to rainwater harvesting systems with indoor storage tanks, it is possible that downspout diverter described above could be used with other types of rainwater harvesting systems connected to downspouts; including ones where the storage tank is located on the outside of a building or buried in the ground adjacent to a building.

While various embodiments have been described above, it should be understood that they have been presented only as illustrations and examples of the present invention, and not by way of limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the appended claims and their equivalents. It will also be understood that each feature of each embodiment discussed herein, and of each reference cited herein, can be used in combination with the features of any other embodiment.

What is claimed is:

1. A downspout diverter comprising:
a main body portion including:
an inlet portion;
a harvesting outlet portion; and
an overflow outlet portion;
wherein when downspout rainwater is received via the inlet portion, the downspout rainwater is directed towards the harvesting outlet portion and when excess rainwater is received via the harvesting outlet portion, the rainwater is directed at the overflow outlet portion.

2. The downspout diverter of claim 1 further comprising a flap covering the overflow outlet portion.

3. The downspout diverter of claim 2 wherein the flap comprises a sealing edge.

4. The downspout diverter of claim 3 wherein the main body portion comprises a seat for receiving the sealing edge.

5. The downspout diverter of claim 1 wherein the main body portion further comprises a housing defining the inlet portion, the harvesting outlet portion and the overflow outlet portion.

6. The downspout diverter of claim 5 wherein the inlet portion and the harvesting outlet portion are connected via a conduit portion.

7. The downspout diverter of claim 6 wherein the housing comprises a pair of body portion components.

8. The downspout diverter of claim 7 wherein the body portion components comprise a set of conduit engaging features whereby when the pair of body portion components are connected, the set of conduit engaging features engaging the conduit to locate the conduit.

9. The downspout diverter of claim 8 wherein the set of conduit engaging features comprises a set of slots.

10. The downspout diverter of claim 9 wherein the conduit comprises flanges for mating with the set of slots.

11. The downspout diverter of claim 8 wherein the set of conduit engaging features comprise a set of protrusions.

12. The downspout diverter of claim 11 wherein the conduit comprises a set of apertures for receiving the set of protrusions.

13. The downspout diverter of claim 7 wherein the conduit comprises a conduit overflow portion whereby rainwater that is received from the harvesting outlet portion is directed to the overflow outlet portion via the conduit overflow portion.

14. The downspout diverter of claim 13 wherein a bottom portion of the main body portion is angled to direct the excess rainwater towards the overflow outlet portion.

15. The downspout diverter of claim 1 wherein the inlet portion is connected to a downspout.

16. The downspout diverter of claim 1 wherein the outlet portion is connected to a pipe.

17. The downspout diverter of claim 1 wherein the main body portion comprises:
a residual zone; and
a flow capacity zone.
